(19) United States
(12) Patent Application Publication
(10) Pub. No.: US 2005/0071226 A1
(43) Pub. Date: Mar. 31, 2005

(54) Method and system for managing dynamic terms and conditions and user interaction

(75) Inventors: Loc Nguyen, San Francisco, CA (US); Bryan Shimko, Scottsdale, AZ (US); Ayman Hammad, Pleasanton, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Visa U.S.A. Inc., San Francisco, CA (US)

(21) Appl. No.: 10/676,723

(22) Filed: Sep. 30, 2003

(51) Int. Cl. G06F 17/60

(52) U.S. Cl. 705/14

(57) ABSTRACT

A method for generating a terms and conditions (T&C) statement for a transaction is disclosed. The method includes: using a portable device to conduct the transaction, the portable device having portable device information; determining if a terms and conditions statement is needed for the transaction based on the portable device information; dynamically generating the terms and conditions statement for the transaction; and outputting the generated terms and conditions statement.

### BACKGROUND OF THE INVENTION

The present invention generally relates to loyalty programs and more specifically to methods and apparatus for dynamically generating a terms and conditions statement for a loyalty transaction.

Loyalty programs are programs that provide cardholders with incentives to shop at certain merchants participating in the loyalty programs. Typically, cardholders are awarded incentives when they shop at the merchants participating in that loyalty program. The incentives may then be redeemed.

Before a cardholder can participate in a loyalty program, terms and conditions for the loyalty program should be affirmatively accepted by the cardholder. Conventionally, the same generic terms and conditions statements are provided to all cardholders participating in the loyalty program. This generic statement is accepted by the cardholder when the cardholder signs up for the program.

The above method of obtaining a cardholder's acceptance of terms and conditions includes many disadvantages. For example, a generic terms and conditions statement may not apply to all cardholders of a loyalty program. Some clauses in the terms and conditions statement may only apply to a certain subset of cardholders and not others. The generic statement cannot be tailored to different cardholders that may have different requirements. Also, after the first terms and conditions statement is accepted by a cardholder, it is hard to make changes to the terms and conditions statement and obtain acceptance for the changed terms and conditions statement.

Accordingly, there is a desire for providing more robust methods and apparatus for managing terms and conditions statements for loyalty programs.

### BRIEF SUMMARY OF THE INVENTION

Embodiments of the present invention relate to generating terms and conditions (T&C) statements for a loyalty transaction. A T&C statement may be generated dynamically for a specific transaction using information specific to the transaction.

In one embodiment, a method for generating a terms and conditions statement for a transaction is disclosed. The method includes using a portable device to conduct the transaction, the portable device having portable device information; determining if a terms and conditions statement is needed for the transaction based on the portable device information; dynamically generating the terms and conditions statement for the transaction; and outputting the generated terms and conditions statement.

The portable device information is used to dynamically generate the terms and conditions statement. The information related to the portable device includes information indicating whether the terms and conditions statement has been accepted before. The terms and conditions statement is not generated if the terms and conditions statement has been accepted before.

The method further includes determining information related to a device outputting the generated terms and conditions statement and dynamically generating the terms and conditions statement based on the information related to the device. The information related to the device includes information indicating whether the device is capable of displaying or printing the terms and conditions statement. The terms and conditions statement is dynamically generated for a display format or a printed format based on the information related to the device.

Furthermore, the method includes receiving input indicating whether the terms and conditions statement is accepted. If the terms and conditions statement has been accepted, then the transaction is processed based on a first set of rules. If the terms and conditions statement has not been accepted, the transaction is processed based on a second set of rules.

The method also includes determining if redemption for the transaction is possible. If redemption is not possible and the generated terms and conditions statement is accepted, information is sent to the portable device indicating an accumulation of an item towards an incentive. If redemption is possible and the terms and conditions statement is accepted, information is sent to the portable device indicating an item for the transaction has been redeemed.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 depicts a system for providing a terms and conditions (T&C) statement according to one embodiment of the present invention;

FIG. 2 depicts a simplified flow chart of a method for distributing information to distribution channels to enable them to generate T&C statements according to one embodiment of the present invention;

FIG. 3 illustrates embodiment of an interface according to embodiments of the present invention;

FIG. 4a illustrates an example of a parameter file according to the embodiments of the present invention;

FIG. 4b illustrates an example of a T&C file according to one embodiment of the present invention;

FIG. 5 illustrates a plurality of templates according to one embodiment of the present invention;

FIG. 6 illustrates a system for generating and outputting T&C statements according to one embodiment of the present invention;

FIG. 7 illustrates a simplified flow chart of a method for dynamically generating a T&C statement according to one embodiment of the present invention; and

FIG. 8 illustrates a simplified logical flow of a method for dynamically generating a T&C statement according to one embodiment of the present invention.

### DETAILED DESCRIPTION OF THE INVENTION

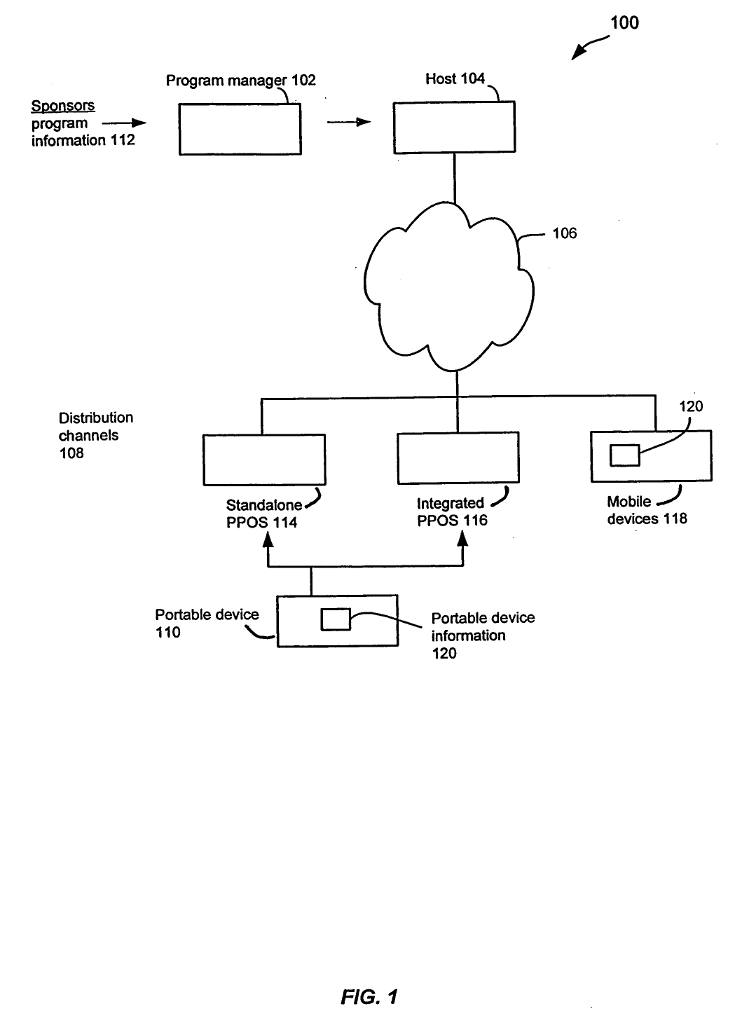

The present invention in the form of one or more exemplary embodiments will now be described. FIG. 1 depicts a system 100 for providing a terms and conditions (T&C) statement according to one embodiment of the present invention. System 100 includes a program manager 102, a host 104, a network 106, distribution channels 108, and one or more portable devices 110.

One or more sponsors 112 are providers of prizes and incentives for loyalty programs. Sponsors 112 are any entities, such as product manufacturers, that can sponsor a loyalty program. Sponsors 112 typically define the parameters of how a loyalty program is provided. This information may include the incentives that are awarded, the requirements that define whether an incentive should be rewarded, the eligible participants, and the terms and conditions that should be accepted by a potential participant before participation in a loyalty program and/or a loyalty transaction is allowed.

As shown, the program information is input into program manager 102. Program manager 102 is a device that formats the loyalty program information in a format readable by host 104. For example, program manager 102 may generate parameters for the loyalty program and also terms and conditions information for the loyalty program from the program information.

In one embodiment, terms and conditions statements include specific legal statements and/or disclosures that are provided during the course of a loyalty transaction that describe the rights of the participant and rules for participation in the loyalty program. Generally, affirmative acceptance of the terms and conditions statement by a participant is necessary before any transactions are processed as loyalty transactions. Once a T&C statement is accepted, acceptance may not be necessary for future transactions. The loyalty transaction may involve the redemption of an incentive, accumulation towards an incentive, or any other loyalty action.

Host 104 receives T&C information and subsequently stores the information in a database. In one embodiment, host 104 then uses the T&C information and creates a T&C file and a parameter file. Host 104 may translate terms from the T&C information and parameters to generate the T&C file and parameter file. In one embodiment, the T&C file includes variables that are used to generate a T&C statement with the values for the variables found in the parameter file. Embodiments of the format of the files will be described in more detail below. Although a T&C file and parameter file are described as separate files, it should be understood that the information may be included in any number of files. Also, other methods of storing the information used to generate T&C statements may be used, such as full text representations of the T&C statement, etc.

In one embodiment, host 104 maintains a T&C file and a parameter file for each loyalty program. However, it should be understood that, in other embodiments, the T&C files and the parameter files may be shared by different loyalty programs. For example, two loyalty programs provided by the same sponsor may share the same parameter file; alternatively, two loyalty programs provided by two different sponsors may share the same T&C file but use two different parameter files. Based on the disclosure and teachings provided herein, a person of ordinary skill in the art will appreciate how to use the T&C files and the parameter files for different loyalty programs.

The T&C and parameter files are then downloaded to distribution channels 108 through network 106. Network 106 may be any network, such as the Internet, a wireless network, a wire line network, a local area network (LAN), a wide area network (WAN), and the like. In one embodiment, the T&C and parameter files may be selectively downloaded to certain distribution channels 108. For example, loyalty programs associated with the T&C and parameter files may be downloaded to applicable distribution channels 108 that will be offering the loyalty programs. Also, some distribution channels 108 may not be able to output a T&C statement and thus may not receive the T&C and parameter files. Periodically, one or more of the T&C and parameter files may be updated by host 104 due to changes resulted from changes made by sponsors 112 or other reasons. The updated T&C and parameter files are then downloaded to applicable distribution channels 108.

Distribution channels 108 include any device capable of generating a T&C statement. In one embodiment, distribution channels 108 include a standalone physical point of sale (PPOS) device 114, an integrated physical point of sale device (PPOS) 116, and a mobile device 118. Distribution channels 108 may perform loyalty transactions offline. In one embodiment, offline indicates that distribution channel 108 does not need to communicate with host 104 to perform the loyalty transaction or to dynamically generate T&C statements. Distribution channel 108 may, however, communicate with host 104 for other reasons, such as for reporting results of transactions, etc.

Stand-alone PPOS device 114 is a stand alone device dedicated to performing point of sale transactions. For example, PPOS 114 includes a point of sale or acceptance point device that may perform loyalty transactions. Point of sale devices found in merchant's stores are examples of stand alone PPOS devices 114.

Integrated PPOS device 116 may be a point of sale or acceptance point device that has been integrated into another device, such as a computer. For example, the integrated PPOS device 116 may be an application on the World Wide Web (WWW), such as a website or an Internet kiosk, accessed through a computing device over the Internet. A website for shopping on the Internet and a card acceptance device may be an example of PPOS 116.

Mobile devices 118 include any mobile devices, such as cellular phones, personal digital assistants (PDA), pocket personal computer (PC), laptop computers, tablet computer, digital viewer etc. One difference between mobile devices 118 and PPOS devices 114 and 116 is that PPOS devices 114 and 116 communicate with a portable device 110 in order to enable a loyalty transaction. Mobile devices 118, however, do not need to communicate with portable device 110 because mobile devices 118 are a portable device 110 and distribution channel 108 together.

Portable devices 110 are devices that are used by loyalty program participants to conduct loyalty transactions. For example, portable devices 110 include smartcards, cellular phones, personal digital assistants (PDAs), pagers, payment cards, security cards, access cards, smart media, transponders, and the like. Each portable device 106 includes a module, such as a computer chip with dedicated hardware, software, embedded software, or any combination thereof, that is used to perform actions associated with loyalty transactions.

Portable devices 110 include, for example, portable device information 120. Similarly, mobile device 118 also includes portable device information 120. Portable device information 120 includes any information that uniquely identifies either portable device 110 or mobile device 118. For example, portable device information 120 may be an identifier, a unique ID, a serial number, an account number, etc. Thus, a user that is associated with portable device 110 or mobile device 118 may be uniquely identified using portable device information 120. Also, portable device information 120 includes any other information related to a loyalty transaction, such as information usable to determine which loyalty programs portable device 110 is eligible for.

A transaction is typically performed between portable device 110 and stand alone PPOS device 114 or integrated PPOS device 116. In another embodiment, mobile devices 118 may participate in a loyalty transaction. In this case, mobile device 118 performs the transaction with host 104, where mobile device 118 performs the functionality of stand alone PPOS device 114 or integrated PPOS device 116. For discussion and illustrative purposes, it will be described that a transaction is being performed between portable device 110 and distribution channel 108. It should be understood, however, that the transaction may be between portable device 110 and PPOS devices 114 and/or 116, or mobile devices 118 and host 104.

A transaction between portable device 110 and distribution channel 108 may be a loyalty transaction for a loyalty program. For example, a loyalty transaction is where a user of the portable device 110 is purchasing items that qualify the user and portable device 110 for an incentive or reward in the loyalty program. Also, in another embodiment, the transaction may be a communication between portable device 110 and distribution channel 108 where an incentive or reward was previously earned and the user of portable device 110 desires to redeem that incentive or reward. Further, a transaction may be a transaction where an accumulation towards an incentive occurs without redemption.

In some cases, the transaction is a transaction that requires the acceptance of a T&C statement by a user of portable device 110. The T&C statement may need to be generated for a number of reasons. For example, a T&C statement may be needed when a transaction qualifies for a loyalty program, an incentive is available, or when a T&C statement has not been previously accepted, or when a T&C statement has been revised since it was last accepted, or when acceptance of the T&C statement needs to be obtained again. If so, a T&C statement is dynamically generated for that transaction and outputted. In one embodiment, the T&C statement may be outputted by displaying, printing out, and/or audibly announcing the statement. The T&C statement may then be accepted or rejected by a user of portable device 110. The acceptance or rejection is received and appropriate actions are taken depending on the response. For example, if the T&C statement is accepted, the loyalty transaction may proceed and any incentives may be rewarded. If the T&C statement is rejected, distribution channel 108 may proceed with a non-loyalty transaction.

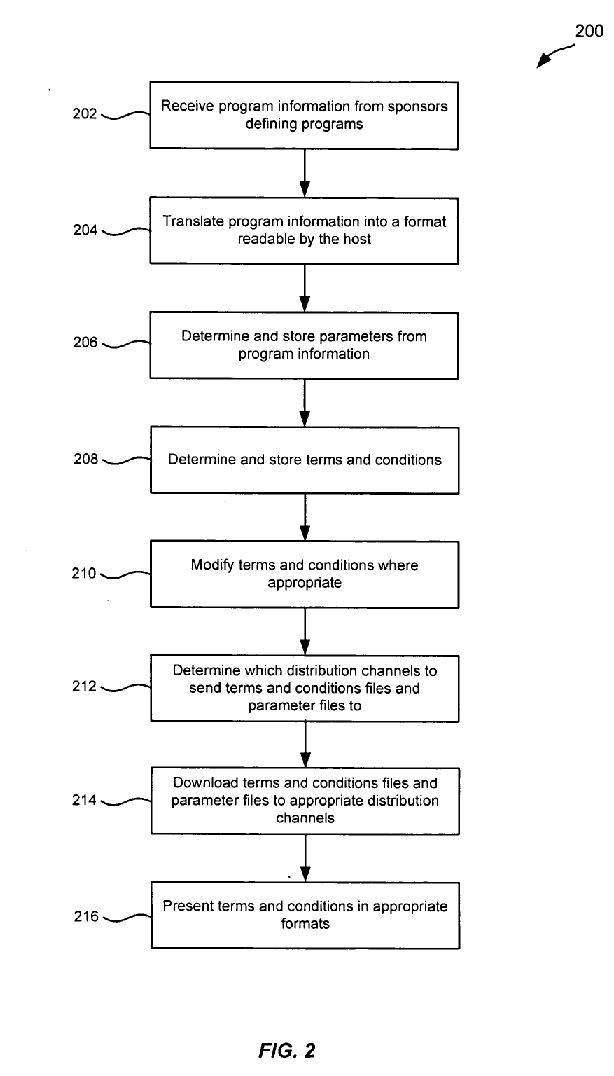

FIG. 2 depicts a simplified flow chart 200 of a method for distributing information to distribution channels 108 to enable them to generate T&C statements according to one embodiment of the present invention. In step 202, program information is received from a sponsor 112 that defines a loyalty program. The information may be received using an interface such as a graphical user interface (GUI), where information is inputted for parameters that will govern the loyalty program.

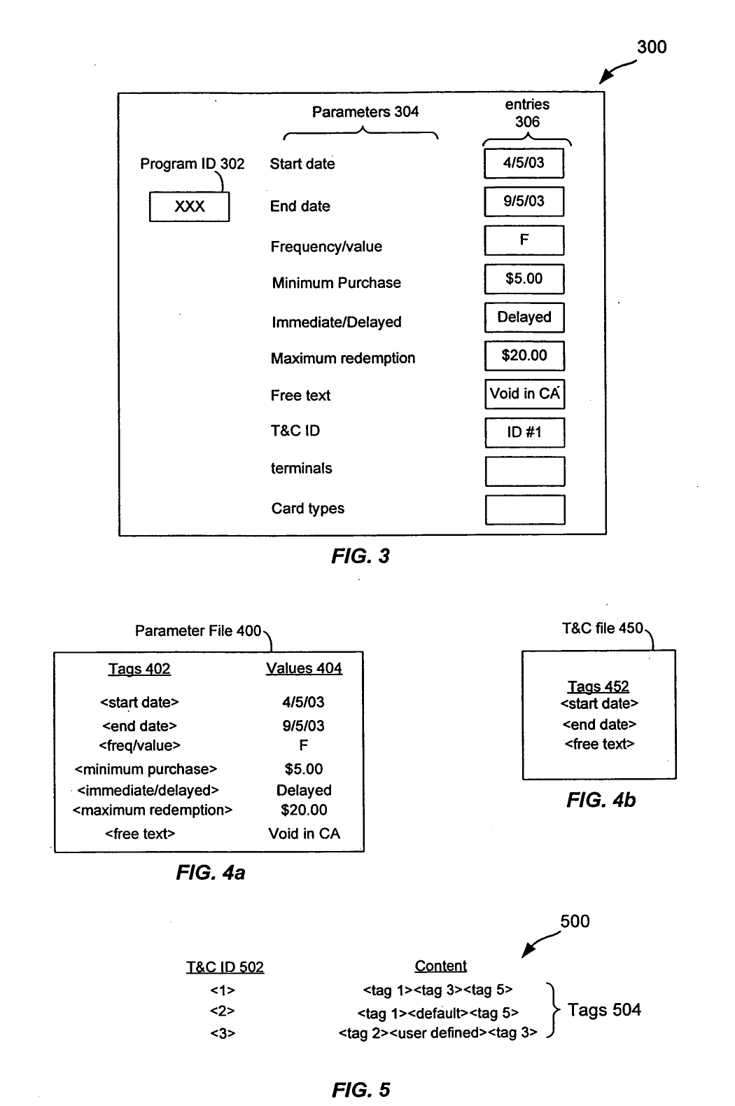

FIG. 3 illustrates an interface 300 according to one embodiment of the present invention. As shown, a plurality of parameters 304 correspond to tags that will be included in parameter and T&C files. A program ID 302 indicates an identifier for a loyalty program. The loyalty program corresponding to the identifier can then have information for parameters 304 inputted using entries 306. In one embodiment, sponsors 112 can enter in information for parameters 304. As shown, information may be entered for the start and end dates, the frequency value, a minimum purchase, whether the reward will be immediate or delayed, a maximum redemption amount, any free text that may be included in the T&C statement, a T&C identifier, which terminals are eligible for the program, and card types. It should be understood that parameters 304 are shown for illustrative purposes and a person skilled in the art will appreciate other parameters 304 that may be included in interface 300. Also, it should be understood that any methods of entering program information into program manager 102 may be used and embodiments of the present invention are not restricted to using interface 300.

Referring back to FIG. 2, in step 204, the program information is translated into a format readable by host 104. For example, dates, monetary values, free text, T&C information, etc. are translated into a uniform format.

In step 206, host 104 determines and stores parameters for the loyalty program. In one embodiment, the determined parameters are stored in a parameter file. FIG. 4a illustrates an example of a parameter file 400 according to one embodiment of the present invention. As shown, tags 402 and values 404 are included in parameter file 400. Tags 402 correspond to parameters 304 of interface 300. For example, tags 402 may be variables that are universal across any parameter files 400 that are created by host 104. Tags 402 define values 404 that are needed to generate a T&C statement. Values 404 correspond to the inputted information that is received for parameters 304 in entries 306. Values 404 may have been translated into a format readable by host 104 and that translated information is stored in parameter file 400. Also, values 404 may be the values that will be outputted for a T&C statement generated using parameter file 400.

Referring back to FIG. 2, in step 208, the T&C information from the program information is determined and stored for the loyalty program. In one embodiment, the T&C information is stored in a T&C file. FIG. 4b illustrates an example of a T&C file 450 according to one embodiment of the present invention. T&C file 450 includes a plurality of tags 452. Tags 452 include tags that correspond to tags 402 of parameter file 400. As shown, T&C file 450 includes the tags <start date>, <end date>, and <free text>. These tags 452 form a template that is used to generate a specific T&C statement for T&C file 450. For example, free text that is specified in parameter file 400 along with the values for <start date> and <end date> are used to generate a T&C statement. It should be noted that all of the tags 402 in parameter file 400 may not be included in T&C file 450. Although all tags may be present in T&C file 450, it is not necessary and the unused tags may be used in other aspects of the loyalty transaction, such as in determining eligibility for the loyalty transaction, etc. Furthermore, values for tags included in T&C file 450 may be derived differently. For example, as mentioned above, parameter file 400 may include tag values that are defined by host 104. Alternatively, some tags values for T&C file 450 may be defined and provided by corresponding distribution channels 108. Hence, different T&C statements can be generated for different T&C files using parameter file 400 and values supplied by corresponding distribution channels 108.

Optionally, in step 210, T&C file 450 and parameter file 400 may be further modified depending on specific situations. For example, where the T&C statement to be generated relates to regulated products, such as, alcohol, tobacco, dairy products and gasoline, certain additions and/or modifications to T&C file 450 and parameter file 400 may be required for legal and/or regulatory reasons. For instance, since different states may have different laws and/or regulations governing sale of regulated products, specific additions and/or modifications may need to be made to T&C file 450 and parameter 400 to reflect the specific legal and regulatory requirements in each state.

Referring back to FIG. 2, in step 212, the distribution channels 108 in which T&C file 400 and parameter file 450 will be downloaded are determined. Different parameter files 400 and T&C files 450 may be sent to different distribution channels 108 in different situations. For example, some distribution channels 108 may be offering different loyalty programs, such as when different merchants offer different programs. One merchant's distribution channels 108 may receive parameter files 400 and T&C files 450 for a first loyalty program and a second merchant may receive parameter files 400 and T&C files 450 for a second loyalty program, etc. In some situations, different distribution channels 108 may not be able to distribute the same T&C statement. Hence, different parameter and T&C files 400 and 450 are downloaded to corresponding distribution channels 108 to allow different versions of the T&C statement to be outputted. Also, some distribution channels 108 may not be able to output a T&C statement and thus will not be sent parameter files 400 and T&C files 450.

When distribution channels 108 are determined, parameter file 400 and T&C file 450 are downloaded to the appropriate distribution channels in step 214.

Optionally, in step 216, the T&C statement is presented in an appropriate format depending on a number of factors including, for example, display capability of the corresponding distribution channel 108, portable device information and user information. Depending on such factors, information from T&C file 450 and parameter file 400 is used accordingly by the distribution channel 108 to generate and display an appropriate T&C statement. In one example, the display capability of the corresponding distribution channel 108 may require the T&C statement to be displayed in a specific format; in another example, a T&C statement in a specific format is to be generated for a certain type of portable device 110; and in yet another example, a T&C statement in a specific format is to be generated for a specific group of users.

The above process may be repeated for any number of loyalty programs. Additionally, a T&C file 450 and parameter file 400 are not limited to information for a single T&C statement or a single loyalty program and may include information to generate T&C statements for multiple loyalty programs. In other words, T&C files 450 and parameter files 400 may be shared interchangeably by multiple loyalty programs. For example, two loyalty programs may use the same T&C file 450 but different parameter files 400, resulting in a T&C statement having more or less the same format but containing different information. Alternatively, two loyalty programs may use the same parameter file 400 but different T&C file 450, resulting in a T&C statement having more or less the same information being displayed in different formats.

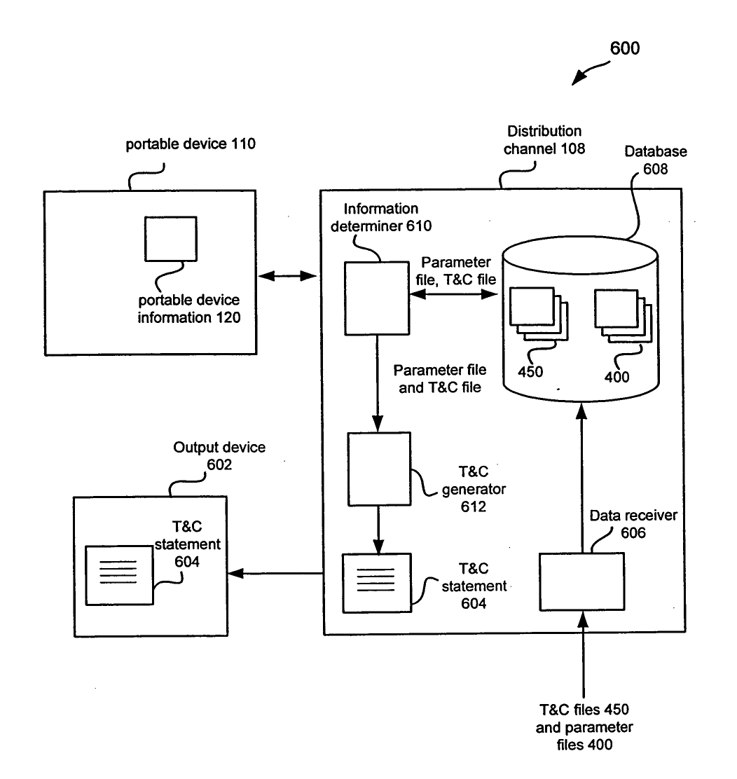

As mentioned above, T&C files 450 may be generated using templates. FIG. 5 illustrates a plurality of templates 500 according to one embodiment of the present invention. A template is identified by a T&C identifier (ID) 502. As shown, the numbers 1, 2, and 3 represent three different templates. Each template includes a number of tags that represent content that will form the substance of the T&C statement that is outputted to a user. The content is in the form a plurality of tags 504.

As illustrated, a template <1> is identified by the tags: <tag 1><tag 3><tag 5>. The tags may be any tags that are supported by system 100. For example, tag 1 may be <start date>, tag 3 may be <end date>, and tag 5 may be <free text> as illustrated in FIG. 4b.

An advantage of using templates 500 is that the templates 500 can be reviewed no matter what the values of the tags are. Thus, the values of the tags may change but the format will remain the same. Similarly, the tags included in a template 500 may change without affecting the corresponding tag values. For example, values for start and end dates may change but the tags stay the same. In one common application, a template is reviewed for legal reasons before any T&C statement is generated based on that template and outputted to a user. The focus of the review is typically on the tags included in the template to ensure that correct types of information are included in the T&C statement without regard to the corresponding tag values. Thus, tags 504 may be reviewed and if approved for legal reasons, any changes to the values of the tags will not need to be reviewed again.

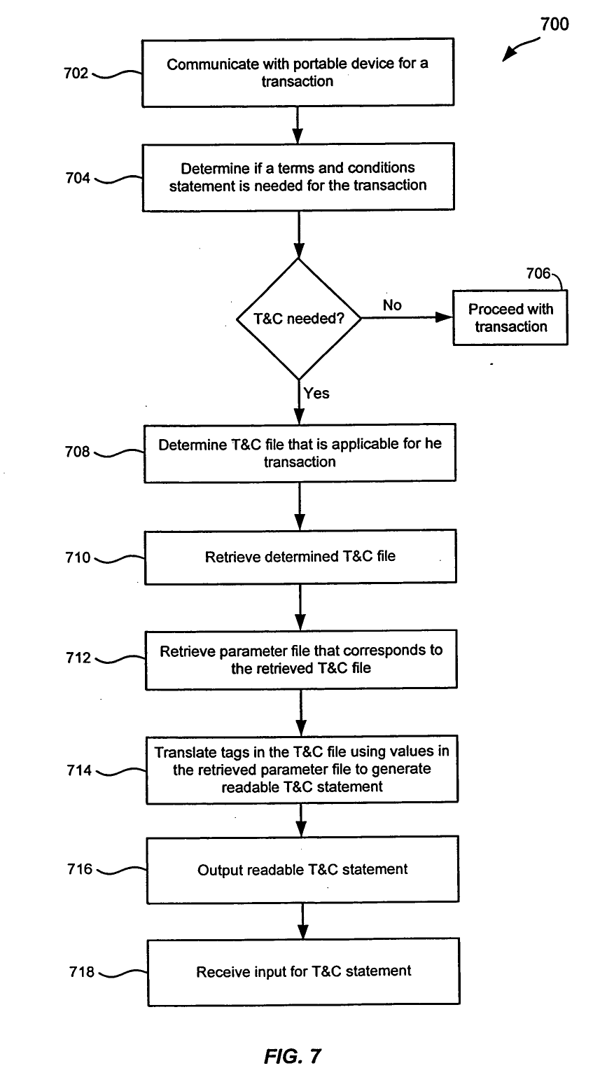

FIG. 6 illustrates a system 600 for generating and outputting T&C statements according to one embodiment of the present invention. The described transaction is between portable device 110 and distribution channel 108.

Before a transaction is initiated, T&C information needed to generate T&C statements is downloaded. For example, T&C files 450 and parameter files 400 are downloaded to distribution channel 108. A data receiver 606 receives and stores the information from files 400 and 450 in a database 608. Although database 608 is shown in distribution channel 108, it should be understood that database 608 may also be remotely located from distribution channel 108.

Once T&C files 450 and parameter files 400 are received at distribution channel 108, distribution channel 108 may generate T&C statements 604 offline. In one embodiment, offline indicates that T&C statements 604 may be generated dynamically for a transaction without any interaction from host 104. Although it is described that a transaction may be performed offline, it should be recognized that distribution channel 108 may contact host 104 at certain times, such as to report the results of any transactions and any incentives that have been rewarded.

A transaction can then be initiated between portable device 110 and distribution channel 108. During a transaction, an information determiner 610 determines information related to portable device 110. For example, portable device information 120 may be determined from information determiner 610. In one embodiment, portable device information 120 may be read from portable device 110. In another embodiment, portable device 110 and distribution channel 108 may communicate to determine portable device information 120.

After determining portable device information 120, information determiner 610 determines if a T&C statement is required for the transaction with portable device 110. In determining if a T&C statement is needed, information determiner 610 may use any information found in database 608, portable device information 120, or any other information. For example, loyalty program information (not shown) may be used to determine if portable device 110 is eligible for an incentive in the loyalty program. The loyalty program may specify that after buying five items, an item will be given away for free. Thus, if portable device information 120 indicates that a fifth item will be purchased in this transaction, then an item should be given away for free. In this case, a T&C statement may be needed before giving away the incentive. In other cases, if information indicates that a T&C statement has not been accepted, a T&C statement may need to be accepted before any loyalty transaction is undertaken.

If a T&C statement is needed, information determiner 610 communicates with database 608 to determine parameter file 400 and T&C file 450 that are applicable for the transaction with portable device 110. For example, depending on the loyalty program, the incentive, or portable device 110, corresponding parameter file 400 and T&C file 450 will be retrieved. In one embodiment, factors specific to the transaction are used to determine an identifier, such as a code, that may be used to retrieve files 400 and 450.

T&C generator 612 is configured to generate T&C statement 604 using parameter file 400 and T&C file 450. In one embodiment, T&C statement 604 is dynamically generated for that specific transaction between portable device 110 and distribution channel 108. T&C statement 604 may be different for different portable devices 110 or may be the same for multiple portable devices 110. Also, T&C statements 604 may be different for different loyalty programs and may be customized for each user of portable devices 110. In any case, T&C statement 604 may be dynamically generated for each transaction and thus may be easily adapted and changed as terms and conditions change.

In one embodiment, the T&C statement is generated using corresponding values found in parameter file 400 for tags found in the T&C file 450. The values are then incorporated into a T&C statement 604.

Once T&C statement 604 is generated, it is sent to an output device 602. As mentioned above, output device 602 may print T&C statement 604, display T&C statement 604, audibly announce T&C statement 604, etc. When T&C statement 604 is outputted, output device 602 is configured to receive an input from a user of portable device 110 indicating an acceptance or rejection of T&C statement 604. For example, the user may select a button that indicates “I accept the T&C,” “I reject the T&C,” or the user may check a box that either indicates the acceptance or rejection of the T&C, etc. Once output device 602 receives the response from the user, the response is recorded by distribution channel 108. As will be described later, the transaction may proceed as a loyalty transaction if the T&C statement was accepted or may proceed as a non-loyalty transaction if the T&C statement was not accepted.

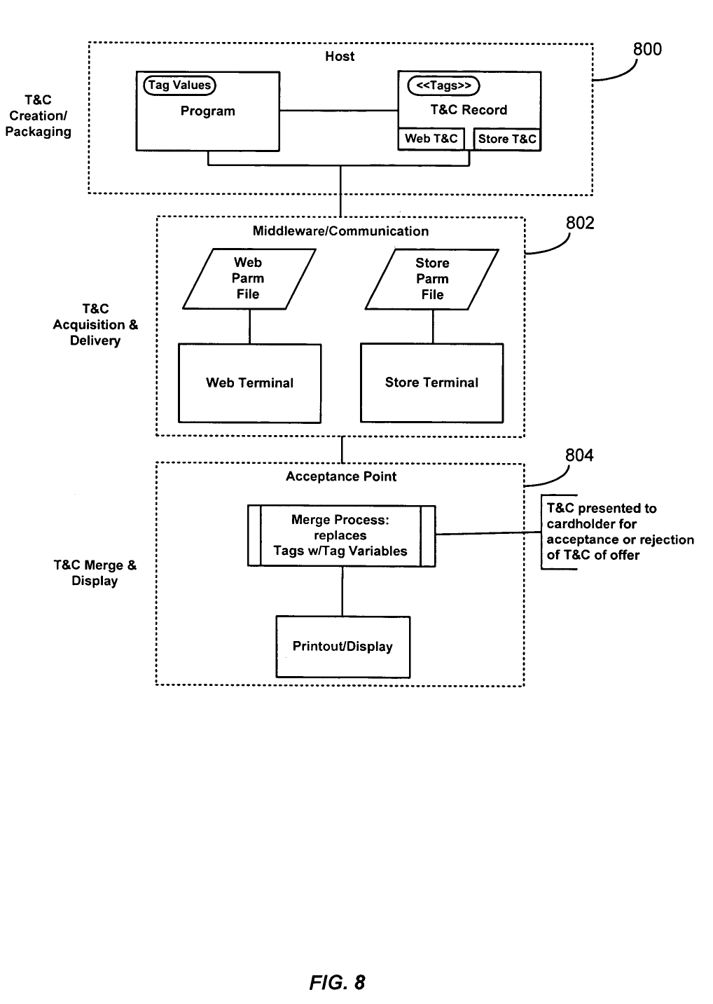

FIG. 7 illustrates a simplified flow chart 700 of a method for dynamically generating a T&C statement according to one embodiment of the present invention. In step 702, distribution channel 108 communicates with portable device 110. In the communication, a loyalty transaction is initiated.

In step 704, distribution channel 108 determines if a T&C statement is needed for the transaction. In determining if a T&C statement is needed for the transaction, distribution channel 108 and portable device 110 may communicate to determine portable device information 120. Information 120 may indicate whether or not the T&C statement has been accepted by the user. Also, it may indicate whether a T&C statement has changed and needs to be accepted or rejected again.

If it is determined that a T&C statement is not needed, in step 706, the process proceeds with the loyalty transaction.

If it is determined that a T&C statement is needed, in step 708, the process identifies a T&C file 450 that is applicable for the transaction. In identifying a T&C file 450 that is applicable for the transaction, portable device information 120 may be used. For example, portable device information 120 may indicate that a user has not accepted a T&C statement before. Also, other factors such as if distribution channel 108 can display or print a T&C statement and/or if information 120 indicates an incentive should be awarded may be used to determine the applicable T&C file 450. Also, information related to the loyalty program associated with the transaction may be used, such as if information 120 indicates that four qualifying purchases have been made and a fifth purchase in this transaction qualifies a user for an incentive. In one embodiment, appropriate information is used to determine a code that is then used to identify the applicable T&C file 450. For example, the code corresponds to an identifier for the stored T&C file 450 or an index to where T&C file 450 is stored.

In step 710, distribution channel 108 retrieves the identified T&C file 450 from database 608.

In step 712, distribution channel 108 retrieves a parameter file 400 that corresponds to the retrieved T&C file 450. In one embodiment, parameter file 400 may be retrieved solely based on a link to the retrieved T&C file 450 or the code determined above for T&C file 450 may also be used to retrieve parameter file 400.

In step 714, tags in the retrieved T&C file 450 are translated using values in the retrieved parameter file 400. The translated tags generate a corresponding T&C statement. Each tag in T&C file 450 corresponds to a tag in parameter file 400. A corresponding value in parameter file 400 for each tag is used to generate the T&C statement. Also, if default or user defined tags are found in T&C file 450, values not found in parameter file 400 may be used, such as values defined at distribution channel 108. Additionally, other information, such as portable device information 120, may be used to generate the T&C statement.

Distribution channel 108 then outputs the generated T&C statement in step 716. The output may be displayed, printed out, audibly announced to a user, etc.

In step 718, input from a user is received for the T&C statement. For example, the user may indicate whether the T&C statement is accepted or rejected. If the T&C statement is accepted, the process continues with a loyalty transaction and incentives may be awarded or accumulation towards the incentive recorded. If the user rejects the T&C statement, the transaction continues as a non-loyalty transaction.

FIG. 8 further illustrates how a T&C statement is generated according to one embodiment of the present invention. At 800, a host is responsible for creating and packaging all the information that is needed for a T&C statement. More specifically, all the tags that are needed for a specific T&C statement under a loyalty program are collected by the host. The tags represent fields to be included in the T&C statement including, for example, “program identification number”, “start date”, “end date”, etc. Then, T&C records having information corresponding to the tags are retrieved. Depending on how the T&C statement is to be delivered and displayed, different T&C records may be retrieved. For example, in some cases, T&C records for web-based applications may be used; in other cases, T&C records for store-based applications may be retrieved.

At 802, the tags for the specific T&C statement and the corresponding T&C records are forwarded to a distribution channel. In other words, the distribution channel acquires the tags and the corresponding T&C records. As mentioned above, the distribution channel may be a store terminal or a point-of-sale device.

At 804, the distribution channel merges the tags and the corresponding T&C records to generate the appropriate T&C statement. The T&C statement may be formatted based on a number of factors including, for example, display constraints of the distribution channel, portable device information and user information. The T&C statement is then displayed or printed out for acceptance or rejection by a user.

In one situation, T&C statements are generated for a user who is using an integrated PPOS 116.

PPOS 116 may be a website being accessed through a computing device. The user selects products for purchase on the website. A website sales application records product IDs and a basket total. An example of the basket total is two items at a price of $2.50 for a total of $5.00.

The website sales application sends a product ID and a purchase total to a loyalty application associated with the website.

The user inserts a portable device 110 into a card acceptance device attached to a personal computer displaying the website.

The website loyalty application compares the product IDs, total purchase values and available rewards determined from portable device 110. Using portable device information 120, it is determined that portable device 110 is eligible for a loyalty program 123, a reward #1 of 50% off a first unit of product X. Also, information 120 also indicates that the accumulations towards the reward are zero.

The loyalty application determines if the purchase qualifies for a reward under the loyalty program. If the purchase does not qualify for a reward, the loyalty application sends a message to the sales application that no rewards apply for the purchase. The sales application then completes the purchase transaction in a normal manner, i.e., a non-loyalty transaction.

If the purchase does qualify for a reward, the loyalty application retrieves portable device information 120 from portable device 110. For example, a code is retrieved from portable device 110. The code is used to determine an appropriate T&C statement to generate.

A number of factors are then considered. Such factors include, for example, whether a T&C statement has been accepted before, whether a distribution channel allows for display and whether redemption is possible. It should be understood that other factors may also be considered. Depending on the results for the factors, different codes may be generated. For example, the application may determine if T&C statements have been accepted before. If T&C statements have been accepted, a first code is used, and if T&C statements have not been accepted, a second code is used. Depending on the code generated, the appropriate T&C statement is created and displayed to the user.

The application then determines if the T&C statement is accepted by the user. If the T&C statement is not accepted by the user, the loyalty application sends a message to the sales application to indicate that no incentives will apply to the purchase.

If the T&C statement is accepted by the user, the loyalty application calculates a reward value and sends the value to the sales application. An example of the calculation where a reward of 50% off the original price of $2.50 was determined to yield an incentive value of $1.25.

The sales application recalculates the basket total and displays the new basket total to the user. The original total of $5.00 minus the reward total of $1.25 equals a new total of $3.75.

The loyalty application then updates T&C information on portable device 110. For example, the portable device 110 is updated to show that a T&C statement has been accepted. Other information on the portable device 110 may also be updated. For example, the accumulation value of a loyalty program is updated to show that redemption has occurred.

Here is another illustration showing a method for performing a transaction for a purchase at a merchant according to one embodiment of the present invention. A user selects products for purchase at a merchant Q.

A PPOS sales application records the product IDs and basket total. The basket includes three products each having a price of $2.50, thus resulting in a basket total of $7.50. The PPOS sales application sends the product ID and purchase total to a loyalty application.

While the basket total is being calculated, the user inserts a portable device 110 into a stand alone PPOS 114.

The loyalty application communicates with portable device 110 to determine portable device information 120 and uses that information, the total purchase value, and/or the product ID, to determine if the purchase qualifies for a reward. For example, the information includes a program “125”, a reward #1 that provides a 10% discount off a fourth unit of product X and the accumulations for this reward are zero.

The loyalty application determines if the purchase qualifies for a reward. If the purchase does not qualify for a reward, the loyalty application sends a message to the sales application that no rewards apply for the purchase. The sales application then completes the purchase transaction in a normal manner without a loyalty transaction.

If the purchase does qualify for a reward, the loyalty application determines T&C information from the portable device 110 and generate an appropriate T&C statement.

Again, various factors may be considered in determining how to generate a T&C statement. Depending on the results for the factors, different codes may be generated. For example, the application may determine if T&C statements have been accepted before. If T&C statements have been accepted, a first code is used, and if T&C statements have not been accepted, a second code is used.

Also, it is determined if the distribution channel 108 allows for display of T&C statements. The application further determines if redemption is possible. If the redemption is not possible, the loyalty application calculates an accumulation value for the portable device 110.

If redemption is possible, the loyalty application compiles and creates a T&C statement for the loyalty program. In one situation, if the distribution channel cannot display the T&C statement, a print file is generated in order to allow the user to print the T&C statement.

The distribution channel 108 prints or displays the T&C statement. The loyalty application then determines if the T&C statement is accepted by the user. The acceptance may be received using various methods described above.

If the T&C statement is accepted by the user, the loyalty application calculates an accumulation value for portable device 110. The loyalty application then updates a T&C value on portable device 110 with a new value. This new value may indicate that an accumulation has taken place.

If the T&C statement is not accepted by the user, the sales application completes the purchase in a normal manner.

The above purchase activity has invoked an accumulation (but no redemption) that will, if accepted, not result in any discount against the purchase. Also, because distribution channel 108 is a stand alone device with display capability, the PPOS application creates a print file that is printed by the PPOS 114. The printed T&C statement may be accepted or rejected by a user. The choice made by the user with respect to the printed T&C statement can be conveyed to the PPOS application via, for example, a user interface.

The following is an illustration for determining whether T&C statements should be generated according to one embodiment of the present invention. In this transaction, customer A makes a purchase of one unit of product Z using a portable device 110 on a website operated by merchant Q and customer B makes a purchase of one unit of product Z using a portable device 110 at a website operated by merchant Q. Each portable device 110 contains the same rewards program that provides a free unit of product M once the customer has purchased two units of product Z. The program parameters further provide that two free units of product M may be provided to any one customer. Customer A is not eligible for a redemption but has not accepted a T&C statement. Customer B is not eligible for a redemption and has already accepted the T&C statement.

Customer A selects products for purchase on merchant Q's website. A website sales application records product IDs and a basket total. The basket has one item, resulting in a basket total at a price of $1.50 of $1.50. The website sales application sends a product ID and purchase total to the loyalty application.

The customer inserts a portable device 110 into a card acceptance device attached to a personal computer.

The website loyalty application compares the product ID, total purchase value, and/or portable device information stored 120 on portable device 110 to determine if the purchase qualifies for an incentive. Portable device information 120 indicates that portable device 110 is eligible for a program “123” that includes a reward #1 for a free unit of product M with a purchase of two units of product Z. The redemptions and accumulations for reward #1 are zero.

If the purchase does not qualify for an incentive, the loyalty application sends a message to sales application to indicate that no rewards apply for purchase. The sales application completes the purchase transaction in a normal manner.

If the purchase does qualify for an incentive, the loyalty application retrieves portable device information 120 from the portable device 110. Portable device information 120 may include a code that is used to generate a certain T&C statement. This code along with a number of factors are used to generate a T&C statement using the appropriate T&C file and parameters file.

Depending on the results for the factors, different codes may be generated. For example, the application may determine if T&C statements have been accepted before. If T&C statements have been accepted, a first code is used, and if T&C statements have not been accepted, a second code is used.

It is then determined if the distribution channel allows for display of T&C statements.

The application also determines if redemption is possible.

If redemption is not possible, the loyalty application calculates an accumulation value for portable device 110. The sales application then completes the purchase transaction in a normal manner.

The loyalty application then compiles and displays the appropriate T&C statement. In this instance, PPOS 116 can only display the T&C statement. In other embodiments, the T&C statement may be printed or audibly announced.

It is then determined if the T&C statement has been accepted by the customer. If the T&C statement is not accepted by the customer, the sales application completes the transaction in a normal manner.

If the T&C statement is accepted by the customer, the loyalty application updates reward data on portable device 110. Also, the loyalty application updates portable device information 120 on portable device 110 to show that a T&C statement has been accepted for this loyalty program and thus another T&C statement does not need to be accepted by a customer in a future transaction.

Customer B selects products for purchase on merchant Q's website. The website sales application records product IDs in a basket total. The basket includes one item of product Z at a price of $1.50 for a basket total of $1.50. The website sales application sends a product ID and purchase total to the website loyalty application.

The customer inserts portable device 110 into a card acceptance device that is attached to a personal computer. The website loyalty application compares the product ID, the total purchase value, and/or portable device information 120 stored on portable device 110. Information 120 is used to determine that portable device 110 is eligible for a program “123” with a reward of #1 a free unit of product M with the purchase of two units of product Z. The customer has two redemptions and four accumulations. This means that two units of product M have been redeemed and four units of product Z have been purchased.

The application determines if the purchase qualifies for a reward. In this case, because the incentive has been redeemed twice, the loyalty application sends a message to the sales application that no rewards apply to the purchase. The sales application completes the purchase transaction in a normal manner. In one situation, the process may continue to record information on portable device 110 to include that a fifth accumulation has accrued.

Accordingly, embodiments of the present invention generate T&C statements dynamically. Distinct T&C statements for specific reward programs and/or specific users may be provided by a sponsor and/or merchant. Thus, a generic statement that covers all potential programs is avoided. Additionally, the dynamically generated T&C statements may be customized for specific distribution channels in which the purchase and loyalty transaction is conducted. For example, different T&C statements may be adapted for different distribution channels such as displays, printers, etc. Also, the T&C statements may be displayable, printable, announced audibly, etc. Moreover, the dynamic generation process also provides a rules-based delivery on T&C statements by recording each acceptance or rejection of the T&C statements on a portable device where that value is used to determine if another T&C statement is needed or appropriate for subsequent transactions.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof.

It should be understood that while the foregoing description with respect to different embodiments is provided in the context of a loyalty program, a person of ordinary skill in the art will know and appreciate how to deploy the present invention in other applications or context where flexible generation of terms and conditions may be desirable. The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

1. A method for generating a terms and conditions (T&C) statement for a transaction, the method comprising:
using a portable device to conduct the transaction, the portable device having portable device information;
determining if a terms and conditions statement is needed for the transaction based on the portable device information;
dynamically generating the terms and conditions statement for the transaction; and
outputting the generated terms and conditions statement.

2. The method of claim 1, wherein dynamically generating the terms and conditions statement comprises using the portable device information to dynamically generate the terms and conditions statement.

3. The method of claim 2, wherein the information related to the portable device comprises information indicating whether the terms and conditions statement has been accepted before; and
wherein the terms and conditions statement is not generated if the terms and conditions statement has been accepted before.

4. The method of claim 1, further comprising:
determining information related to a device outputting the generated terms and conditions statement; and
wherein dynamically generating the terms and conditions statement comprises dynamically generating the terms and conditions statement based on the information related to the device.

5. The method of claim 4, wherein the information related to the device comprises information indicating whether the device is capable of displaying or printing the terms and conditions statement,
wherein the terms and conditions statement is dynamically generated for a display format or a printed format based on the information related to the device; and
wherein outputting the terms and conditions statement comprises displaying the terms and conditions statement in the displayed format or printed format.

6. The method of claim 5, further comprising:
receiving input indicating whether the terms and conditions statement is accepted;
if the terms and conditions statement has been accepted, processing with the transaction based on a first set of rules; and
if the terms and conditions statement has not been accepted, processing the transaction based on a second set of rules.

7. The method of claim 6, further comprising:
determining if redemption for the transaction is possible;
if redemption is not possible and the generated terms and conditions statement is accepted, sending information to the portable device indicating an accumulation of an item towards an incentive; and
if redemption is possible and the terms and conditions statement is accepted, sending information to the portable device indicating an item for the transaction has been redeemed.

8. The method of claim 1, wherein the transaction is a loyalty transaction in a loyalty program.

9. A method for generating terms and conditions (T&C) statements, the method comprising:
obtaining parameters for a loyalty program;
determining T&C information for the loyalty program from the parameters;
sending the T&C information to a distribution channel, wherein the T&C information enables the distribution channel to dynamically generate T&C statements for one or more portable devices for corresponding loyalty transactions.

10. The method of claim 9, wherein the T&C information comprises a plurality of tags.

11. The method of claim 10, wherein the plurality of tags comprises a template that is used to dynamically generate a T&C statement for at least one of the one or more portable devices.

12. The method of claim 9, further comprising determining a plurality of parameters for the T&C information, wherein the plurality of parameters are used to dynamically generate the terms and conditions statements with the T&C information.

13. The method of claim 9, further comprising:
receiving input information for the loyalty program; and
translating the input information into the T&C information.

14. A device for using managing terms and conditions (T&C) statements for use in connection with loyalty transactions, the device comprising:
an information determiner configured to determine information specific to a loyalty transaction;
logic to dynamically generate a T&C statement based on the determined information for the loyalty transaction; and
an output to output the generated T&C statement.

15. The device of claim 14, wherein the information specific to the loyalty transaction comprises a T&C file that includes information useable to generate the T&C statement.

16. The device of claim 15, wherein the information specific to the loyalty transaction comprises a parameter file that includes information useable to generate the T&C statement.

17. The device of claim 16, wherein the T&C file includes tags that correspond to parameters in the parameter file, the corresponding parameters being used to generate the T&C statement.

18. The device of claim 14, wherein the information specific to the loyalty transaction includes information retrieved from a portable device.

19. The device of claim 18, wherein the information retrieved from the portable device includes user information and information relating to a loyalty program.

20. The device of claim 14, wherein the T&C statement is generated based on characteristics of the device.

21. The device of claim 14, further comprising a communicator configured to output the T&C statement.

22. The device of claim 21, wherein the communicator comprises at least one of a printer, display, and speaker.

23. The device of claim 14, further comprising a receiver configured to receive an input indicating an acceptance or rejection of the T&C statement.

24. A device for managing terms and conditions (T&C) statements, the device comprising:
a plurality of T&C files and a plurality of parameter files useable to generate T&C statements;
control logic configured to select a T&C file from the plurality of T&C files and a parameter file from the plurality of parameter files for a loyalty transaction; and
control logic configured to dynamically generate a T&C statement for the transaction using the selected T&C file and the selected parameter file.

25. The device of claim 24, wherein the control logic selects the T&C file and the parameter file using information specific to the loyalty transaction.

26. The device of claim 25, wherein the information specific to the loyalty transaction comprises at least one of portable device information for a portable device, information related to how the device can output the T&C statement, information that indicates if the T&C statement has been accepted before, and information that indicates if redemption is possible for the loyalty transaction.

27. The device of claim 26, further comprising control logic configured to communicate with the portable device to save information on the portable device regarding whether the T&C statement has been accepted by a user of the portable device.

28. A method for generating terms and conditions (T&C) statements for a plurality of portable devices, the method comprising:
determining if a T&C statement is needed for a loyalty transaction;
if the T&C statement is needed, determining information specific to the loyalty transaction;
generating the T&C statement dynamically using the information specific to the loyalty transaction; and
outputting the generated T&C statement.

29. The method of claim 28, wherein determining information specific to the loyalty transaction comprises:
determining portable device information specific to a portable device; and
wherein generating the T&C statement comprises using the portable device information to dynamically generate the T&C statement.

30. The method of claim 29, wherein the information related to the portable device comprises at least one of information indicating whether the T&C statement has been accepted before, wherein the T&C statement is not generated and outputted if the T&C statement has been accepted before.

31. The method of claim 28, wherein determining information specific to the loyalty transaction comprises:
determining information related to a device outputting the generated T&C statement; and
wherein generating the T&C statement further comprises dynamically generating the T&C statement using the information related to the device.

32. The method of claim 31, wherein the information related to the device comprises information indicating whether the device is capable of displaying or printing the T&C statement;
wherein the T&C statement is generated for a display format or a printed format based on the information related to the device; and
wherein outputting the generated T&C statement comprises displaying the T&C statement in the display format or printed format.

33. The method of claim 28, further comprising:
receiving input indicating whether the T&C statement is accepted;
if the T&C statement has been accepted, processing the loyalty transaction according to a first set of rules; and
if the T&C statement has not been accepted, processing the loyalty transaction according to a second set of rules.

34. The method of claim 33, further comprising:
determining if redemption for the loyalty transaction is possible;
if there is no redemption and the generated T&C statement is accepted, sending information to the portable device indicating an accumulation of an item towards an incentive; and
if there is redemption and the T&C statement is accepted, sending information to the portable device indicating an item for the loyalty transaction has been redeemed.

35. A system for managing terms and conditions (T&C) statements, the system comprising:
one or more portable devices;
a plurality of distribution channels, each distribution channel comprising:
an information determiner configured to interact with a portable device to determine information specific to a loyalty transaction;
logic to generate a T&C statement for the loyalty transaction based on the determined information; and
an output to output the generated T&C statement.

36. The system of claim 35, wherein the information specific to the loyalty transaction comprises portable device information specific to the portable device.

37. The system of claim 35, wherein the information specific to the loyalty transaction comprises at least one of information related to the output, information indicating if the T&C statement has been accepted before, and information indicating if redemption is possible for the loyalty transaction.

38. The system of claim 35, further comprising a host, the host configured to communicate with the plurality of distribution channels and transmit information used to determine how to generate the T&C statement.

39. A method for processing loyalty transactions for a plurality of loyalty programs, the method comprising:
using a portable device to conduct a transaction;
determining a loyalty program applicable for the transaction;
determining portable device information specific to the portable device;
determining terms and conditions (T&C) information related to the loyalty program and useable for generating a T&C statement for the transaction;
generating the T&C statement using the T&C information;
outputting the generated T&C statement;
receiving an indication indicating whether the T&C statement was accepted or rejected by a user of the portable device; and
processing the transaction based on acceptance or rejection by the user.

40. The method of claim 39, wherein processing the transaction comprises processing the transaction as a loyalty transaction if the T&C statement is accepted by the user.

41. The method of claim 40, further comprising:
determining an incentive to apply to the loyalty transaction; and
applying the incentive to the loyalty transaction.

42. The method of claim 41, further comprising communicating with the portable device to save information on the portable device indicating that the incentive was awarded.

43. The method of claim 40, further comprising:
determining an accumulation value based on purchase of an item for the loyalty transaction; and
communicating with the portable device to save the accumulation value on the portable device.

44. The method of claim 39, wherein processing the transaction comprises processing the transaction as a non-loyalty transaction if the T&C statement is rejected by the user.

45. The method of claim 39, further comprising communicating with the portable device to store information that indicates whether the T&C statement has been accepted or rejected.

46. A system for managing terms and conditions (T&C) statements, comprising:
a plurality of distribution channels each configured to store one or more parameter files and one or more T&C files; and
a plurality of portable devices each configured to interact with at least one of the plurality of distribution channels;
wherein a portable device interacts with a distribution channel in order to conduct a transaction;
wherein the distribution channel determines whether a T&C statement is to be generated for the transaction; and
wherein if the T&C statement is to be generated, the distribution channel selects a parameter file from the one or more stored parameter files and a T&C file from the one or more stored T&C files and generates the T&C statement using the selected parameter file and the selected T&C file.

47. The system of claim 46 further comprising:
a host configured to communicate with the plurality of distribution channels and download the one or more parameter files and one or more T&C files selectively to each of the plurality of distribution channels.

48. The system of claim 47 wherein the host is further configured to:
receive information related to loyalty programs from one or more sponsors; and
generate the one or more parameter files and the one or more T&C files using the information related to the loyalty programs.

49. The system of claim 48 wherein the host is further configured to:
update the one or more parameter files and the one or more T&C files; and
download the updated one or more parameter files and the updated one or more T&C files selectively to the plurality of distribution channels.

50. The system of claim 46 wherein the transaction is a loyalty transaction under a loyalty program.

51. The system of claim 46 wherein the distribution channel determines whether to generate the T&C statement based on at least one of a plurality of criteria including whether the T&C statement is needed for the transaction, whether the T&C statement has been previously accepted, whether the T&C statement has been revised since it was last accepted and whether acceptance of the T&C statement needs to be obtained again.

52. The system of claim 46 wherein the portable device includes portable device information; and
wherein the portable device information is used by the distribution channel to determine whether the T&C statement is to be generated for the transaction.

53. The system of claim 52 wherein if the T&C statement is to be generated, the distribution channel uses the portable device information to select the parameter file from the one or more stored parameter files and the T&C file from the one or more T&C files and also uses the portable device information to generate the T&C statement.

54. The system of claim 53 wherein the portable device information includes at least one of information related to a user of the portable device, information related to a loyalty program and information related to the portable device.

55. The system of claim 53 wherein if the T&C statement is to be generated, the distribution channel further uses information related to the distribution channel to generate the T&C statement.

56. The system of claim 46 wherein, the distribution channel is configured to output the T&C statement to a user of the portable device for review after the T&C statement is generated.

57. The system of claim 56 wherein the distribution channel is further configured to output the T&C statement in one of a plurality of formats.

58. The system of claim 56 wherein the distribution channel is further configured to receive a choice made by the user with respect to the T&C statement.

59. The system of claim 58 wherein the choice made by the user with respect to the T&C statement includes accepting the T&C statement or rejecting the T&C statement.

60. The system of claim 59 wherein if the choice made by the user with respect to the T&C statement is accepting the T&C statement, the distribution channel processes the transaction in a first manner; and
wherein if the choice made by the user with respect to the T&C statement is rejecting the T&C statement, the distribution channel processes the transaction in a second manner.

61. The system of claim 46 wherein the selected T&C file includes a plurality of tags;
wherein the selected parameter file includes a plurality of values corresponding to the plurality of tags.

62. The system of claim 61 wherein contents of the T&C statement are changed by modifying the selected parameter file without modifying the T&C file.
